(19) United States
(12) Patent Application Publication
(10) Pub. No.: US 2002/0105117 A1
(43) Pub. Date: Aug. 8, 2002

(54) Split-leaf spring

(76) Inventor: John Calvert, Lancaster, CA (US)

Correspondence Address: Scott W. Kelley, KELLY BAUERSFELD LOWRY & KELLEY, LLP, Suite 1650, 6320 Canoga Avenue, Woodland Hills, CA, 91367, US

(21) Appl. No.: 09/776,246

(22) Filed: Feb. 2, 2001

(51) Int. Cl. F16F 1/18

(52) U.S. Cl. 267/36.1; 267/52

(57) ABSTRACT

A split-leaf spring assembly for motor vehicle is disclosed having first and second leaf springs having second ends thereof overlapping. The overlapping portions of the leaf springs are connected. A bracket is fixed to the first leaf spring and extends around a portion of the second leaf spring. Similarly, a bracket is fixed to the second leaf spring and extends around a portion of the first leaf spring. The overlapping portions of the first and second leaf springs are configured to reinforce a high-stress area of the assembly. The leaf springs may be of different thicknesses, and are interchangeable.

### BACKGROUND OF THE INVENTION

The present invention relates to motor vehicle suspension systems. More particularly, the present invention relates to a split-leaf spring assembly that is interchangeable and designed to reinforce areas of high stress.

Although there are many different types of rear suspension systems available for use in motor vehicles, the conventional leaf spring is most widely used. One such leaf spring is referred to as a monoleaf spring assembly as it has a single leaf spring that extends from one connection point with the vehicle typically rearward of the rear axle, to another vehicle connection point forward of the rear axle. As the vehicle travels, tremendous forces can be applied to the leaf spring assembly, particularly at its connection point with the rear axle. In rear-wheel drive vehicles, during acceleration the leaf spring is subject to twisting forces which are opposite in direction and magnitude to the acceleration of the drive wheels. Under extreme conditions, such as high performance racing cars, the leaf spring can break with catastrophic consequences.

Other suspensions can be used which provide sufficient strength under such conditions. However, these systems suffer disadvantages in that they are often complicated, expensive or add a significant amount of weight to the vehicle. For example, leaf spring assemblies having multiple plates stacked on one another provide additional strength, but lack flexibility and increase the overall weight of the car. Altering the suspension and spring qualities of previously used systems is often difficult if not entirely impossible.

Accordingly, there is a need for a leaf spring assembly which provides reinforcement to high-stress areas of the assembly, while being simple in design and light in weight. What is also needed is a leaf spring assembly which is readily interchangeable to alter the suspension qualities of the assembly. The present invention fulfills these needs and provides other related advantages.

### SUMMARY OF THE INVENTION

The present invention resides in a split-leaf spring assembly for use in motor vehicles, such as high performance racing cars, that are designed to reinforce areas of high stress and which are also readily interchangeable. The split-leaf spring assembly comprises first and second leaf springs each having opposite first and second ends. The second ends of the first and second leaf springs are overlapped and connected with appropriate means, such as a bolt. A bracket is fixed to the second end of the first leaf spring so as to extend around a portion of the second leaf spring. Similarly, a bracket is fixed to the second end of the second end of the second leaf spring and extends around a portion of the first leaf spring. The first and second leaf springs may have different cross-sectional thicknesses.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a partially exploded perspective view of a split-leaf spring assembly embodying the present invention attached to an axle of a vehicle; and

FIG. 2 is a elevational side view of the split-leaf spring assembly shown in FIG. 1, in relation to a tire shown in phantom.

### DETAILED DESCRIPTION OF THE PREFERRED EMBODIMENT

As shown in the drawings for purposes of illustration, the present invention is concerned with a split-leaf spring assembly, generally designated by the reference number 10. The assembly 10 is designed to provide reinforcement of high-stress areas to avoid catastrophic breakage.

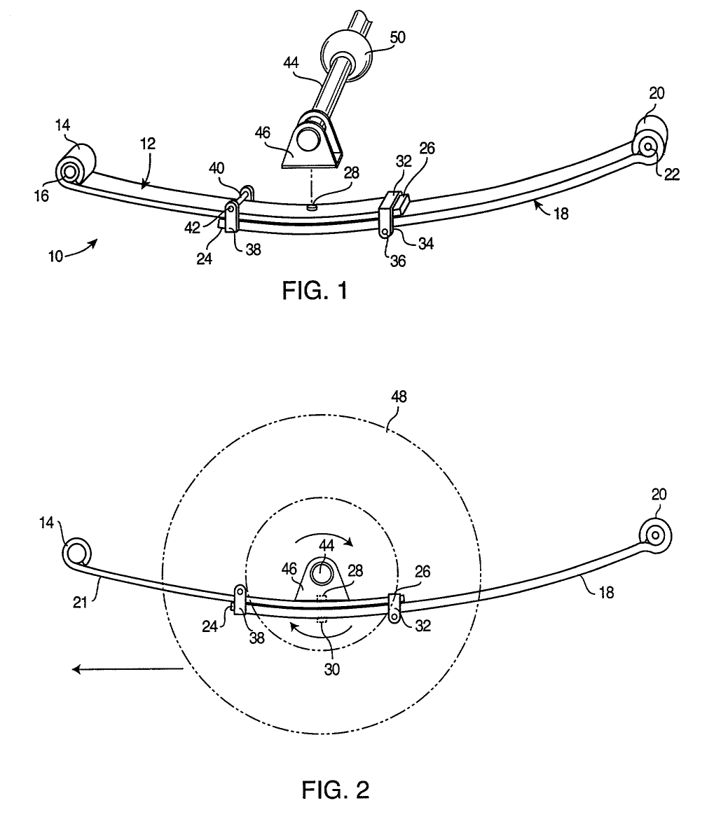

With reference to FIG. 1, the assembly 10 includes a first leaf spring 12 having a first end 14 configured for connection to a vehicle's chassis. Typically, the first end 14 is curled inward around an insert 16 which forms an eye connector. The remainder of the leaf spring 12 is formed in typical fashion in that it has a rectangular cross-section of relative uniform thickness and width, although not limited to such. The leaf spring 12 is constructed of a durable material, such as steel, having spring qualities. The spring 12 is constructed to have a pre-set bow or curvature and length.

The assembly 10 includes a second leaf spring 18 having similar qualities as the first leaf spring 12. The second leaf spring 18 has a first end 20 which is curled around an eye connector insert 22 for attachment to the chassis of the vehicle. Although not limited to such, the leaf spring 18 extends from the first end 20 to a second end 24 in typical fashion in that it has a generally rectangular cross-section of relatively uniform thickness and width throughout the length thereof. The second leaf spring 18 is constructed of spring steel or the like and has a pre-set curvature and length.

The assembly 10 is created by overlapping a second end 26 of the first leaf spring 12 with the second end 24 of the second leaf spring 18 to form a predetermined area of overlap of the two leaf springs 12 and 18. Holes are drilled through the first and second leaf springs 12 and 18 at their overlapping portion so that a bolt 28 or the like can be inserted therethrough to connect the overlapping leaf springs 12 and 18 to one another. This is typically done at approximately the center point of the overlapping portion. A nut 30 is attached to the bolt 28 extending through the overlapping first and second leaf springs 12 and 18 to securely hold the leaf springs 12 and 18 to one another, while allowing the bolt 28 to be removed and either of the leaf springs 12 or 18 to be interchanged as will be more fully discussed herein.

A U-shaped bracket 32 is attached to the first leaf spring 12 adjacent the second end 26 thereof. The bracket 32 extends over a portion of the second leaf spring 18. A bolt 34 is inserted through apertures 36 of the open-face bracket 32 creating a travel-restrictive gap between the bolt 34 and the second leaf spring 18. Such placement of the bolt 34 allows flexation and travel of the second leaf spring 18 in response to forces exerted thereto, while also serving to restrict such flexation and travel to the gap provided.

Similarly, a second bracket 38 is attached to the second leaf spring 18 adjacent the second end 24 thereof. The bracket 38 is also preferably U-shaped so as to extend over a portion of the first leaf spring 12. A bolt 40 is inserted through apertures 42 of the bracket to provide a travel restrictive gap for the first leaf spring 12, as described above.

The constructed leaf spring assemblies 10 are typically attached to the rear axle 44 of the vehicle by conventional or other appropriate means. In the drawings, the assembly 10 is connected to the rear axle 44 of the vehicle by way of a mounting housing 46 which is attached to the rear axle 44. The housing 46 has an aperture therethrough which can be aligned with the apertures extending through the first and second leaf springs 12 and 18 so as to accept bolt 28 to secure both the first and second leaf springs 12 and 18 to the housing 46. In conventional fashion, a pair of assemblies 10 are attached to the rear axle 44 between each rear tire 48 and differential 50 of the vehicle.

As illustrated in the accompanying drawings, the split-leaf assembly 10 is constructed such that the second ends 24 and 26 of the first and second leaf springs 12 and 18 overlap at the rear axle 44 of the vehicle. This is by design as in rear-wheel drive vehicles, during acceleration the leaf spring assembly 10 is subject to high stress, twisting forces which are typically opposite in direction and magnitude to the acceleration of the tires 48. Thus, as illustrated in FIG. 2, as the tire is accelerated in a forward direction, that is the tires rotating in a counter-clockwise manner, there is experienced a differential rotation in a clockwise direction which conveys an enormous amount of stress upon the leaf spring assembly 10. In prior art monoleaf spring assemblies, such forces could cause the leaf spring to crack or break resulting in catastrophic consequences not only to the leaf spring assembly but potentially to the vehicle as well. The overlap provided by the present invention provides additional reinforcement and also serves to extend the high stress area along the length of the leaf springs 12 and 18, even beyond the area of overlap. The configuration of the split-leaf assembly 10 also allows the rear end of the vehicle to remain in alignment during such acceleration.

Aside from the above-described advantages, the split leaf assembly 10 design also allows the use of different thicknesses of leaf springs on either the front or rear half of the assembly 10, as illustrated in FIG. 2. Thus, either the first or second leaf springs 12 or 18 may be of a greater thickness than the other leaf spring 12 or 18. This can be advantageously implemented to affect the spring characteristics of the assembly 10, provide additional support to maintain the rear end of the vehicle in alignment during acceleration, as well as further reinforcing areas of high stress. Due to the fact that nut 30 can be removed from bolt 28, the first and second leaf springs 12 and 18 can be separated from one another and only one of the leaf springs 12 or 18 interchanged instead of replacing the entire assembly 10. This interchangeable aspect of the assembly 10 presents great flexibility as well as an enormous cost benefit. The simple design of the assembly 10 enables one of ordinary skill to interchange the leaf springs 12 or 18 at a racetrack in minutes if deemed necessary.

Although an embodiment of the invention has been described in detail for purposes of illustration, various further modifications may be made without departing from the spirit and scope of the invention. Accordingly, the invention is not to be limited, except as by the appended claims.

What is claimed is:

1. A split-leaf spring assembly for a motor vehicle, comprising:
a first leaf spring having opposite first and second ends;
a second leaf spring having opposite first and second ends, wherein the second ends of the first and second leaf springs overlap; and
means for connecting overlapping portions of the first and second leaf springs.

2. The assembly of claim 1, wherein the connecting means comprises a bolt.

3. The assembly of claim 1, including a bracket fixed to the second end of first leaf spring and extending around a portion of the second leaf spring.

4. The assembly of claim 1, including a bracket fixed to the second end of the second leaf spring and extending around a portion of the first leaf spring.

5. The assembly of claim 1, wherein the first and second leaf springs have different cross-sectional thicknesses.

6. The assembly of claim 1, wherein the overlapping portions of the first and second leaf springs are configured to reinforce a high-stress area of the split-leaf spring assembly.

7. A split-leaf spring assembly for a motor vehicle, comprising:
a first leaf spring having opposite first and second ends;
a second leaf spring having opposite first and second ends, wherein the second ends of the first and second leaf springs overlap;
a bracket fixed to the first leaf spring and extending around a portion of the second leaf spring;
a bracket fixed to the second leaf spring and extending around a portion of the first leaf spring; and
means for connecting overlapping portions of the first and second leaf springs;
wherein the overlapping portions of the first and second leaf springs are configured to reinforce a high-stress area of the split-leaf spring assembly.

8. The assembly of claim 7, wherein the connecting means comprises a bolt.

9. The assembly of claim 7, wherein the first and second leaf springs have different cross-sectional thicknesses.
